(19) United States
(12) Patent Application Publication
(10) Pub. No.: US 2021/0201670 A1
(43) Pub. Date: Jul. 1, 2021

(54) INFORMATION PROCESSING DEVICE, INFORMATION PROCESSING METHOD, AND INFORMATION PROCESSING SYSTEM

(71) Applicant: Toyota Jidosha Kabushiki Kaisha, Toyota-shi Aichi-ken (JP)

(72) Inventor: Daiki Kaneichi, Tokyo-to (JP)

(21) Appl. No.: 17/130,344

(22) Filed: Dec. 22, 2020

(30) Foreign Application Priority Data
Dec. 25, 2019 (JP) 2019-234918

(51) Int. Cl. G08G 1/01

(52) U.S. Cl. CPC G08G 1/0145; G08G 1/0116; G08G 1/0129; G08G 1/0133

(57) ABSTRACT

In an information processing apparatus according to the present disclosure, when moving objects scheduled to pass through a predetermined road section are detected, the types of the detected moving objects are specified. Thus, an estimated traffic volume for each type of the moving objects scheduled to pass through the predetermined road section is calculated. Then, the number and/or the types of lanes to be formed in the predetermined road section are set based on the estimated traffic volume for each type of the moving objects scheduled to pass through the predetermined road section.

### CROSS REFERENCE TO THE RELATED APPLICATION

This application claims the benefit of Japanese Patent Application No. 2019-234918, filed on Dec. 25, 2019, which is hereby incorporated by reference herein in its entirety.

### BACKGROUND

### Technical Field

The present disclosure relates to a technique for managing lanes formed on a road.

### Description of the Related Art

In recent years, there has been known a technique of changing road signs by using lane lighting or the like with light emitters embedded in a road (for example, see Patent Literature 1). In addition, there has also been known a technique of changing a division (partition) form and a use form of a predetermined area by using lane lighting (for example, see Patent Literature 2).

### CITATION LIST

### Patent Literature

Patent Literature 1: Japanese Patent Application Laid-Open Publication No. 2006-104896

Patent Literature 2: Japanese Patent Application Laid-Open Publication No. 2005-141363

### SUMMARY

An object of the present disclosure is to provide a technique capable of utilizing a road in a more efficient manner.

The present disclosure can be taken as an information processing apparatus. The information processing apparatus in this case may be comprising a controller including at least one processor. The processor may be configured to execute:

detecting moving objects that are scheduled to pass through a predetermined road section;

specifying types of the moving objects scheduled to pass through the predetermined road section;

calculating an estimated traffic volume for each type of the moving objects scheduled to pass through the predetermined road section; and

setting the number and/or types of lanes to be formed in the predetermined road section based on an estimated traffic volume for each type of moving objects that are scheduled to pass through the predetermined road section.

The present disclosure can also be taken as an information processing method. The information processing method in this case may be configured to cause a computer to execute:

a detection step of detecting moving objects that are scheduled to pass through a predetermined road section;

a specification step of specifying types of the moving objects scheduled to pass through the predetermined road section;

a calculation step of calculating an estimated traffic volume for each type of the moving objects scheduled to pass through the predetermined road section; and

a setting step of setting the number and/or types of lanes to be formed in the predetermined road section based on an estimated traffic volume for each type of moving objects that are scheduled to pass through the predetermined road section.

The present disclosure can also be taken as an information processing system. The information processing system in this case may be comprising:

a road marking device arranged in a predetermined road section and configured to change the positions and number of lanes to be formed in the predetermined road section by forming road markings indicating demarcation lines at optional positions;

a display device arranged in the predetermined road section and configured to display regulatory signs indicating traffic distributions of lanes formed in the predetermined road section; and

an information processing apparatus for controlling the road marking device and the display device;

wherein the information processing apparatus may be comprising a controller including at least one processor. The controller may be configured to execute:

detecting moving objects that are scheduled to pass through the predetermined road section;

specifying types of the moving objects scheduled to pass through the predetermined road section;

calculating an estimated traffic volume for each type of the moving objects scheduled to pass through the predetermined road section; and

setting the number and/or types of the lanes to be formed in the predetermined road section by changing the positions and number of the road markings to be formed by the road marking device and by changing the regulatory signs to be displayed by the display device, based on the estimated traffic volume for each type of the moving objects scheduled to pass through the predetermined road section.

In addition, as another aspect, there is provided an information processing program for causing a computer to execute the information processing method, or a non-transitory storage medium storing the information processing program in a computer readable form.

According to the present disclosure, it is possible to provide a technique capable of utilizing a road in a more efficient manner.

### BRIEF DESCRIPTION OF THE DRAWINGS

FIG. 1 is a view illustrating an outline of a lane lighting system.

FIG. 2 is a view illustrating a configuration of a lane lighting apparatus.

FIG. 3 is a view illustrating a hardware configuration of a user terminal, a server apparatus, and the lane lighting apparatus.

FIG. 4 is a block diagram illustrating a functional configuration of the server apparatus.

FIG. 5 is a view illustrating a configuration example of a moving object information table.

FIG. 6 is a view illustrating a configuration example of an estimated traffic volume table.

FIG. 7 is a view illustrating another configuration example of the estimated traffic volume table.

FIG. 8 is a first view illustrating a lane setting example.

FIG. 9 is a second view illustrating another lane setting example.

FIG. 10 is a third view illustrating a further lane setting example.

FIG. 11 is a fourth view illustrating a still further lane setting example.

FIG. 12 is a flowchart illustrating a flow of processing performed by the server apparatus.

### DESCRIPTION OF THE EMBODIMENTS

A feature of the present disclosure is to efficiently utilize a road with a limited width by changing the number and types of lanes to be formed in a predetermined road section in accordance with the volume (or amount) and types of moving objects scheduled to pass through the predetermined road section. The types of the moving objects referred to herein include a pedestrian, a bicycle, a motorcycle, a motor vehicle, or the like. The “lanes” referred to herein are traffic zones that are formed by dividing a road by demarcation lines (or lane markings). In addition, the “types of lanes” referred to herein are classification according to the types of the moving objects that are allowed to pass through the lanes. The types of lanes include, for example, a lane dedicated to vehicles, a lane dedicated to pedestrians, a lane dedicated to bicycles, a lane dedicated to pedestrians and bicycles, a lane dedicated to business vehicles, a lane dedicated to autonomous driving vehicles, a lane dedicated to emergency vehicles, etc.

Here, in a road on which a plurality of lanes can be formed, the type of each lane is conventionally fixed to a preset type in most cases. In addition, in a road on which a plurality of lanes dedicated to vehicles are formed, some of the lanes may be changed to lanes dedicated to business vehicles such as buses in a predetermined time zone. However, the volume and types of moving objects traveling on a road can change at any time, and hence, it is necessary to flexibly change the number and types of lanes according to such changes.

In contrast to this, in an information processing apparatus according to the present disclosure, a controller detects moving objects scheduled to pass through a predetermined road section. At this time, for example, the controller may detect the moving objects scheduled to pass through the predetermined road section by obtaining a scheduled moving route of each moving object and extracting those moving objects which include the predetermined road section in their scheduled moving routes. The controller specifies the types of the moving objects thus detected. For example, the controller may specify the types of the detected moving objects by obtaining information on the types of the moving objects in the predetermined road section in their scheduled moving routes. The information on the type of each moving object is, for example, information indicating a moving or traveling method when the user of the moving object moves in the predetermined road section. As the moving method, there can be mentioned a walk, a bicycle, a motorcycle, a motor vehicle, and so on. Then, if the moving method taken by the user at the time of moving in the predetermined road section is a walk, the type of the moving object moving in the predetermined road section is specified as a pedestrian. In addition, if the moving method taken by the user at the time of moving in the predetermined road section is to use a bicycle, the type of the moving object moving in the predetermined road section is specified as a bicycle. Moreover, if the moving method taken by the user at the time of moving in the predetermined road section is to use a motorcycle, the type of the moving object moving in the predetermined road section is specified as a motorcycle. Further, if the moving method taken by the user at the time of moving in the predetermined road section is to use a motor vehicle, the type of the moving object moving in the predetermined road section is specified as a motor vehicle. Here, note that the information about the scheduled moving route of each moving object and the type of each moving object may be obtained, for example, by the information processing apparatus communicating with a terminal used for route guidance of the user, or a terminal used for schedule management of the user. The “terminal” referred to herein is, for example, a terminal (a smart phone, a mobile phone, a tablet computer, a notebook computer, a wearable computer, or the like) that is carried by the user. Also, the “terminal” may be a navigation system or the like mounted on a vehicle (a bicycle, a motorcycle, or a motor vehicle) on which the user rides.

When the types of the moving objects scheduled to pass through the predetermined road section are specified, the controller calculates an estimated traffic volume for each type of the moving objects scheduled to pass through the predetermined road section (hereinafter, also referred to as a “type-specific estimated traffic volume in some cases”). Then, the controller sets the number and/or types of lanes to be formed in the predetermined road section based on the type-specific estimated traffic volumes. Thus, the number and/or the types of the lanes to be formed in the predetermined road section are appropriately and flexibly changed according to the type-specific estimated traffic volumes. As a result, even if the volume and types of moving objects passing through the predetermined road section change in a fluid manner, it is possible to allow the moving objects to pass smoothly. Therefore, the predetermined road section can be utilized in a more efficient manner.

Here, in cases where the moving objects scheduled to pass through the predetermined road section include a first type of moving objects and a second type of moving objects, the number and types of lanes may be set in accordance with each type of the estimated traffic volumes. For example, when the estimated traffic volume of the first type of moving objects is larger than that of the second type of moving objects, the controller may set the number of lanes through which the first type of moving objects are allowed to pass to be larger than the number of lanes through which the second type of moving objects are allowed to pass. Accordingly, it is possible to alleviate or suppress traffic congestion when the first type of moving objects passes through the predetermined road section. On the other hand, for the second type of moving objects, it is possible to suppress an excessively large number of lanes from being set with respect to the traffic volume thereof.

In addition, in cases where a plurality of first lanes, which are lanes through which motor vehicles are allowed to pass, are set in the predetermined road section, the types of the first lanes may be set according to the estimated traffic volume for each type of the motor vehicles. For example, when the estimated traffic volume of business vehicles among the motor vehicles that are scheduled to pass through the predetermined road section is greater than a predetermined threshold value, the controller may set at least one of the plurality of first lanes as a lane dedicated to the business vehicles. The “business vehicles” referred to herein are, for example, buses for transporting passengers, trucks for transporting cargo, or the like. Also, the “predetermined threshold value” is a value that is assumed to make it difficult for business vehicles to smoothly pass through the predetermined road section when the volume (number) of business vehicles passing through the predetermined road section is greater than the predetermined threshold value. When a lane dedicated for the business vehicles is set as described above, the business vehicles can smoothly travel in the predetermined road section. This also makes it possible to transport passengers or cargo without delay.

In addition, when the estimated traffic volume of autonomous driving vehicles among the motor vehicles that are scheduled to pass through the predetermined road section is greater than a predetermined threshold value, the controller may set at least one of the plurality of first lanes as a lane dedicated to the autonomous driving vehicles. Here, from the point of view of improving the traffic safety of motor vehicles, it is desirable that autonomous driving vehicles and manual driving vehicles (i.e., vehicles in which the drivers manually perform driving operation) travel in different lanes. On the other hand, if a dedicated lane is set for the autonomous driving vehicles in cases where a proportion of the estimated traffic volume of the autonomous driving vehicles among the estimated traffic volume of the motor vehicles is relatively small, there will be a possibility that congestion is likely to occur in a lane through which the manual driving vehicles are allowed to pass. In contrast to this, if a dedicated lane is set for the autonomous driving vehicles on condition that the estimated traffic volume of the autonomous driving vehicles among the motor vehicles scheduled to pass through the predetermined road section is greater than the predetermined threshold value, it is possible to achieve a balance between traffic safety and congestion suppression. The “predetermined threshold value” referred to herein is a value that is assumed to be appropriate for achieving the above balance.

Moreover, in cases where an emergency vehicle is included among the motor vehicles that are scheduled to pass through the predetermined road section, the controller may set at least one of the plurality of first lanes as a lane dedicated to the emergency vehicle. In this case, the emergency vehicle can quickly pass through the predetermined road section. Thus, the emergency vehicle can arrive at a destination more quickly.

Further, in cases where the sum of the estimated traffic volume for pedestrians and the estimated traffic volume for bicycles exceeds a predetermined upper limit value, the controller may set the whole of the predetermined road section as lanes dedicated to pedestrians and bicycles. Here, for example, in cases where an event is held in the vicinity of the predetermined road section, the volume (or amount) of pedestrians and bicycles passing through the predetermined road section may become excessive. In such a case, if a third lane through which motor vehicles and/or motorcycles are allowed to pass is set in the predetermined road section in addition to a second lane that is a lane dedicated to pedestrians and bicycles, the passage of pedestrians and bicycles may be delayed. In addition, if there is no physical separation at a boundary between the second lane and the third lane, a pedestrian or a bicycle may protrude from the second lane to the third lane. On the other hand, if the whole of the predetermined road section is set as lanes dedicated to pedestrians and motor vehicles in cases where the sum of the estimated traffic volume of pedestrians and the estimated traffic volume of bicycles exceeds the predetermined upper limit value, pedestrians and bicycles are allowed to pass through the predetermined road section smoothly and safely. The “predetermined upper limit value” referred to herein is a value at which it is assumed that the passage of pedestrians and bicycles may be delayed, even if at least one lane through which moving objects other than pedestrians and bicycles are allowed to pass is formed in the predetermined road section in cases where the estimated traffic volume of pedestrians and bicycles exceeds the predetermined upper limit value.

Here, in the predetermined road section, there may be provided a road marking device that forms road markings indicating demarcation lines (lane markings) at optional positions, and a display device that displays regulatory signs for regulating the types of lanes. In this case, the controller can set the number of lanes to be formed in the predetermined road section by changing the positions and the number of the road markings to be formed by the road marking device. In addition, the controller can also set the type of each lane by changing the regulatory signs to be displayed by the display device.

Hereinafter, a specific embodiment of the present disclosure will be described with reference to the drawings. The dimensions, materials, shapes, relative arrangements, and the like of component parts described in the embodiment are not intended to limit the technical scope of the present disclosure to only those unless otherwise described.

### Embodiment

In this embodiment, reference will be made to an example in which an information processing apparatus according to the present disclosure is applied to a lane lighting system.

(Outline of Lane Lighting System)

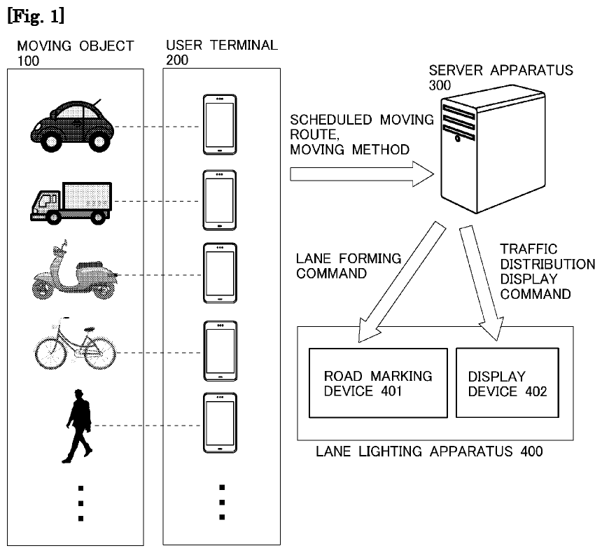

FIG. 1 is a view illustrating an outline of the lane lighting system. The lane lighting system in the present example changes the number and types of lanes over time in accordance with the volume and types of moving objects 100 that are scheduled to pass through a predetermined road section. Such a lane lighting system includes moving objects 100, user terminals 200, a server apparatus 300, and a lane lighting apparatus 400. The types of the moving objects 100 in the present example include a pedestrian, a bicycle, a motorcycle, a motor vehicle, and the like. The types of the moving objects 100 are not limited to the examples described above, but may be changed as appropriate.

The user terminals 200 are small-sized computers that moves together with the moving objects 100. For example, the user terminals 200 may each be a small-sized computer carried by a user (pedestrian) moving on foot or a user riding a vehicle (motor vehicle, motorcycle, or bicycle). The user terminals 200 may each be a computer such as a car navigation system mounted on a vehicle. A predetermined application for utilizing a route guidance service is installed in each of the user terminals 200. When moving to a desired destination, the user of a user terminal 200 can set a scheduled moving or traveling route or the like by having his or her user terminal 200 run the above predetermined application. For example, the user inputs various kinds of information such as a departure place, a destination place, a departure date and time, or an arrival date and time to the user terminal 200, thereby setting a scheduled moving or traveling route and a moving or traveling method from the departure place to the destination place. When the scheduled moving route and the moving method are set in this way, the user terminal 200 provides route guidance to the user in accordance with the scheduled moving route and the moving method. Here, note that well-known methods can be used as a method of setting the scheduled moving route and the moving method, and as a method of route guidance. In addition, the user terminal 200 in the present example transmits information (moving information) related to the movement of the user to the server apparatus 300 when the scheduled moving route and the moving method have been set on the user terminal 200. The moving information in the present example includes information related to the scheduled moving route, information related to the moving method for the scheduled moving route, information related to a time zone (scheduled moving time zone) of the scheduled moving route, and the like. The moving information may be obtained by an application for managing the schedule of the user. For example, the information related to the scheduled moving route and the scheduled moving time zone may be obtained based on a moving schedule to be registered on the application. In addition, the moving method for the scheduled moving route may be predicted based on the actual performance or result of the moving method when the user moved along the scheduled moving route in the past.

The server apparatus 300 obtains the type-specific estimated traffic volumes in each time zone based on the moving information received from each user terminal 200. The type-specific estimated traffic volumes are each an estimated traffic volume for each type of the moving objects 100 that are scheduled to pass or pass through the predetermined road section. At this time, the server apparatus 300 first detects moving objects 100 with the predetermined road section included in their scheduled moving routes. Then, the server apparatus 300 specifies the types of the moving objects 100 thus detected. In addition, the server apparatus 300 specifies time zones (scheduled passage time zones) in which the moving objects 100 are scheduled to pass through the predetermined road section, based on the information related to the scheduled moving time zones of the detected moving objects 100. Then, the server apparatus 300 calculates the type-specific estimated traffic volumes for each time zone based on the types and the scheduled passage time zones of the detected moving objects 100. When the type-specific estimated traffic volumes for each time zone are obtained, the server apparatus 300 sets the number and types of lanes to be formed in the predetermined road section for each time zone, based on the type-specific estimated traffic volumes for each time zone. At this time, the number and types of lanes to be formed in the predetermined road section are set by the server apparatus 300 controlling the lane lighting apparatus 400.

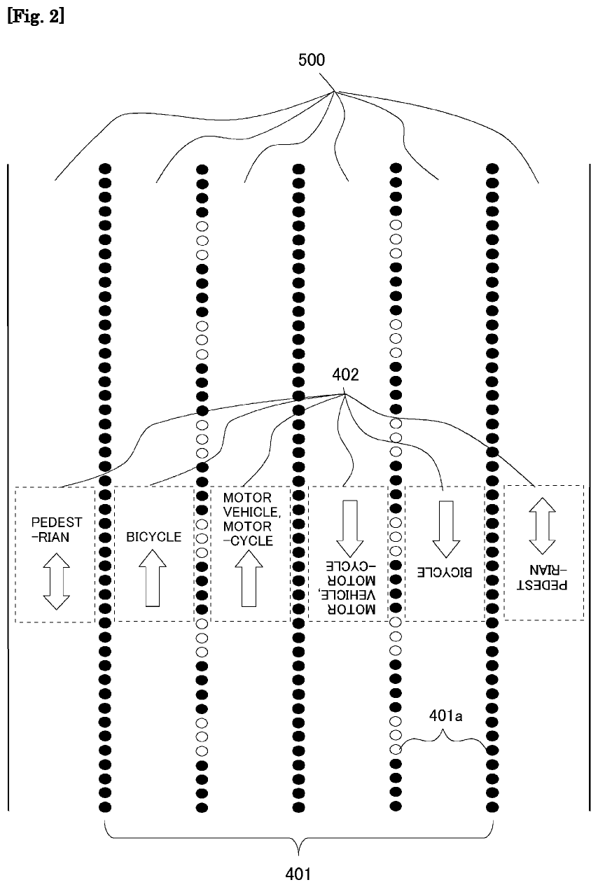

The lane lighting apparatus 400 is a device that optionally changes the number and types of lanes to be formed in the predetermined road section. The lane lighting apparatus 400 in the present example includes a road marking device 401 and a display device 402. The road marking device 401 changes the number of lanes by optionally changing the positions and the number of demarcation lines (lane markers) indicating the boundaries of the lanes. For example, as illustrated in FIG. 2, the road marking device 401 in the present example is configured to include a plurality of light emitters 401a embedded in the predetermined road section, and forms demarcation lines at optional positions by causing some light emitters 401a at optional positions among the plurality of light emitters 401a to emit light. In the example illustrated in FIG. 2, a light emitter 401a indicated by a black circle in the drawing indicates a light-emitting state, and a light emitter 401a indicated by a white circle in the drawing indicates a non-light emitting state. The road marking device 401 is not limited to the above-described configuration, and may be configured to project a demarcation line on a road surface by irradiating the road surface with laser light or the like from above the road. The display device 402 is a device that displays information related to the traffic distribution of each of the lanes to be formed by the road marking device 401. That is, the display device 402 displays regulatory signs for regulating the type and/or the moving direction of the moving objects 100 that are allowed to pass through each lane. For example, as illustrated in FIG. 2, the display device 402 in the present example is embedded in the road and configured to display characters and/or symbols on the road surface. Here, note that the display device 402 may be configured to project characters and/or symbols onto the road surface from above the road.

(Hardware Configuration of Lane Lighting System)

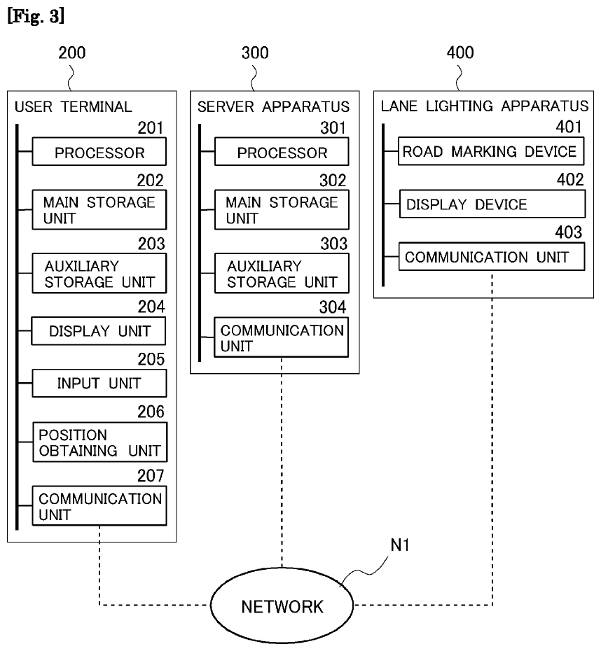

Next, components of the lane lighting system will be described in detail. FIG. 3 is a view illustrating a hardware configuration of a user terminal 200, the server apparatus 300, and the lane lighting apparatus 400.

The user terminal 200 is, for example, a small computer that can be carried by a user, such as a smart phone, a mobile phone, a tablet terminal, a wearable computer or the like, or a computer mounted on a vehicle, such as a car navigation system. The user terminal 200 transmits the moving information to the server apparatus 300 when the scheduled moving route of the user and the moving method for the scheduled moving route have been set on the user terminal 200. Such a user terminal 200 includes a processor 201, a main storage unit 202, an auxiliary storage unit 203, a display unit 204, an input unit 205, a position obtaining unit 206, a communication unit 207, and so on.

The processor 201 is, for example, a central processing unit (CPU) or a digital signal processor (DSP). The processor 201 controls the user terminal 200, thereby performing various information processing operations. The main storage unit 202 includes, for example, a random access memory (RAM), a read only memory (ROM), and so on. The auxiliary storage unit 203 is, for example, an erasable programmable ROM (EPROM) or a hard disk drive (HDD). In addition, the auxiliary storage unit 203 may include a removable medium, i.e., a portable recording medium. The removable medium is, for example, a universal serial bus (USB) memory, a disk recording medium such as a compact disc (CD), a digital versatile disc (DVD) or the like.

The auxiliary storage unit 203 stores various kinds of programs, various kinds of data, and various kinds of tables in a recording medium in a readable and writable manner. The auxiliary storage unit 203 also stores an operating system (OS), various kinds of programs, various kinds of tables, and so on. Here, note that a part or all of these pieces of information may be stored in the main storage unit 202. A part or all of the information stored in the main storage unit 202 may also be stored in the auxiliary storage unit 203.

The display unit 204 is, for example, a liquid crystal display (LCD), an electroluminescence (EL) panel, or the like. The input unit 205 includes, for example, a touch panel or a push button capable of inputting symbols, such as characters, etc., a microphone capable of inputting voice, a camera capable of capturing a moving image or a still image, and so on. The position obtaining unit 206 is a device that obtains the current position of the user terminal 200, and is typically configured to include a GPS receiver or the like. The communication unit 207 is a device for connecting the user terminal 200 to a network N1. The communication unit 207 is connected to the network N1 by using, for example, mobile communication such as 5G (5th Generation) or LTE (Long Term Evolution). The communication unit 207 may be connected to the network N1 by making use of narrow band communication, such as dedicated short range communications (DSRC), Wi-Fi (registered trademark), or the like. Accordingly, the communication unit 207 can communicate with other devices (e.g., the server apparatus 300, etc.) via the network N1. In this example, the communication unit 207 transmits the moving information of the user, etc., to the server apparatus 300 via the network N1. The network N1 referred to herein is, for example, a wide area network (WAN), which is a global public communication network such as the Internet, or any of other communication networks.

The hardware configuration of the user terminal 200 is not limited to the example illustrated in FIG. 3, but component elements thereof may be omitted, replaced, or added as appropriate. In addition, a series of processes executed by the user terminal 200 can also be executed by hardware, but can be executed by software.

The server apparatus 300 controls the lane lighting apparatus 400 based on the type-specific estimated traffic volumes in each time zone, thereby setting the number and types of lanes 500 to be formed in the predetermined road section in each time zone. Such a server apparatus 300 corresponds to an “information processing apparatus” according to the present disclosure. The server apparatus 300 has a configuration of a general computer. That is, the server apparatus 300 includes a processor 301, a main storage unit 302, an auxiliary storage unit 303, a communication unit 304, and so on. The processor 301, the main storage unit 302, the auxiliary storage unit 303, the communication unit 304, and so on are connected to one another via a bus. The processor 301, the main storage unit 302, and the auxiliary storage unit 303 are the same as those of the user terminal 200, and hence, the description thereof will be omitted. The communication unit 304 transmits and receives information between external devices and the server apparatus 300. The communication unit 304 is, for example, a local area network (LAN) interface board or a radio or wireless communication circuit for radio or wireless communication. Such a communication unit 304 is connected to the network N1. Here, note that the hardware configuration of the server apparatus 300 is not limited to the example illustrated in FIG. 3, but component elements thereof may be omitted, replaced, or added as appropriate. In addition, a series of processes executed by the sever apparatus 300 can be executed by hardware, but can also be executed by software.

The lane lighting apparatus 400 is a device that changes the number and types of lanes to be formed in the predetermined road section. Such a lane lighting apparatus 400 is configured to include the road marking device 401, the display device 402, and the communication unit 403. As illustrated in the above-mentioned FIG. 2, the road marking device 401 includes a plurality of light emitters 401a embedded in the predetermined road section. The light emitters 401a are, for example, light emitting diodes (LEDs), optical fibers, or the like. In the example illustrated in FIG. 2, the plurality of light emitters 401a are embedded in a grid pattern on the road surface of the predetermined road section. Then, the road marking device 401 displays a demarcation line on the road surface by causing some of the light emitters 401a arranged in an optional column (an array in the longitudinal direction of the road) to emit light. At this time, the road marking device 401 can change the type of a demarcation line (such as a vehicle traffic zone boundary line, a roadway center line, a vehicle traffic zone outermost line, etc.) by setting the light emitters 401a of an optional row (an array in the width direction of the road) to a non-light emitting state.

As illustrated in FIG. 2, the display device 402 is embedded at a plurality of locations in the road surface in the predetermined road section. The display device 402 comprises, for example, LCDs or EL panels whose surfaces are each covered with a transparent protective member such as tempered glass. In the example illustrated in FIG. 2, a plurality of display devices 402 are embedded side by side in the width direction of the road. Then, each display device 402 displays information on the traffic distribution of each of the lanes 500 to be formed by the road marking device 401. That is, the display device 402 displays regulatory signs for regulating the types and/or the moving direction of the moving objects 100 that are allowed to pass through each lane. For example, in a lane through which motor vehicles and motorcycles are allowed to pass, the display device 402 may display character information indicating that the types of the moving objects 100 allowed to pass through the lane are “motor vehicles and motorcycles”, and may also display a symbol that regulates the moving direction of the moving objects.

The communication unit 403 transmits and receives information between external devices and the lane lighting apparatus 400. The communication unit 403 is, for example, a LAN interface board or a radio or wireless communication circuit for radio or wireless communication.

Here, note that the road marking device 401 and the display device 402 of the lane lighting apparatus 400 may be electrically connected to the server apparatus 300 without through the communication unit 403.

(Functional Configuration of Server Device)

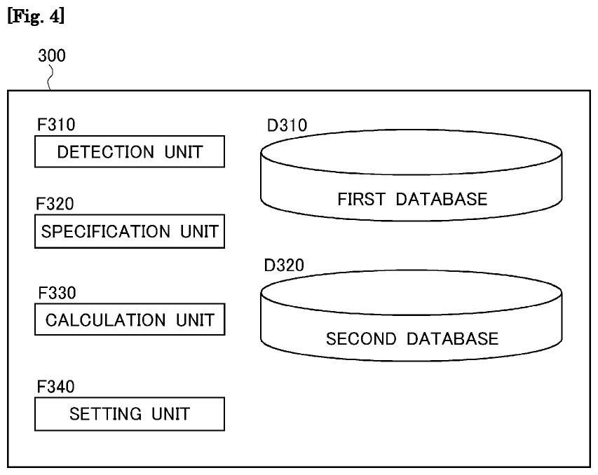

Next, a functional configuration of the server apparatus 300 will be described based on FIG. 4. The server apparatus 300 in the present example includes, as its functional components, a detection unit F310, a specification unit F320, a calculation unit F330, a setting unit F340, a first database D310, and a second database D320.

The detection unit F310, the specification unit F320, the calculation unit F330, and the setting unit F340 are achieved by the processor 301 executing a program stored in the main storage unit 302 or the auxiliary storage unit 303. Here, note that any or part of the detection unit F310, the specification unit F320, the calculation unit F330, and the setting unit F340 may be formed by a hardware circuit. In addition, any of the detection unit F310, the specification unit F320, the calculating unit F330 and the setting unit F340, or a part of their processes may be implemented by another computer connected to the network N1. For example, each process included in the detection unit F310, each process included in the specification unit F320, each process included in the calculation unit F330, and each process included in the setting unit F340 may be implemented by separate individual computers.

The first database D310 and the second database D320 are built by a program of a database management system (DBMS) that is executed by the processor 301. Specifically, the program of the DBMS manages the data stored in the auxiliary storage unit 303, thereby building the first database D310 and the second database D320. The first database D310 and the second database D320 are, for example, relational databases.

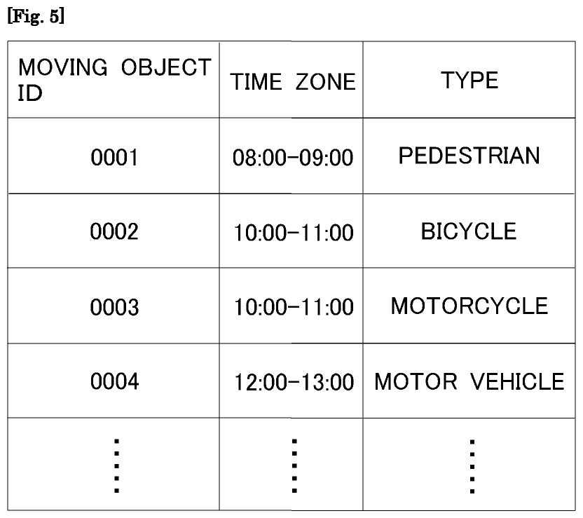

Here, the first database D310 stores information related to the moving objects 100 scheduled to pass through the predetermined road section. In the first database D310, a time zone in which each moving object 100 is scheduled to pass through the predetermined road section is associated with information related to the type of each moving object 100. Here, a configuration example of the information stored in the first database D310 will be described based on FIG. 5. FIG. 5 is a view illustrating a table configuration of the first database D310. Here, note that the configuration of a table stored in the first database D310 (hereinafter, referred to as a “moving object information table” in some cases) is not limited to the example illustrated in FIG. 5, but fields can be added, changed, or deleted as appropriate.

The moving object information table illustrated in FIG. 5 has fields for moving object ID, time zone, and type. In moving object ID fields, information (moving object ID) is registered for specifying each moving object 100 scheduled to pass through the predetermined road section. A moving object ID is assigned, for example, when the server apparatus 300 receives moving information from a user terminal 200. The moving object ID may be a user ID that is assigned when the user of each moving object 100 subscribes to the route guidance service. In time zone fields, information indicating a time zone in which each moving object 100 is scheduled to pass through the predetermined road section is registered. In type fields, information on the type of each moving object 100 is registered. The information related to the type of each moving object 100 is based on a moving method when its user passes through the predetermined road section. For example, when the user intends to move on foot in the predetermined road section, “pedestrian” is registered in the type fields. If the user intends to move by bicycle in the predetermined road section, “bicycle” is registered in the type fields. If the user intends to move by motorcycle in the predetermined road section, “motorcycle” is registered in the type fields. If the user intends to move by motor vehicle in the predetermined road section, “motor vehicle” is registered in the type fields. Here, note that in cases where the moving method when the user moves in the predetermined road section is to use a motor vehicle, if the motor vehicle on which the user rides is an autonomous driving vehicle, “autonomous driving vehicle” may be registered in the type fields. In addition, if the motor vehicle in which the user rides is a business vehicle such as a bus for transporting passengers or a cargo vehicle for transporting cargo, “business vehicle” may be registered in the type fields. Also, if the vehicle in which the user rides is a vehicle (emergency vehicle) that runs on a road in order to achieve emergency services, such as an ambulance vehicle, a fire vehicle, or a police vehicle, “emergency vehicle” may be registered in the type fields. The registration of information for each field as described above is performed by the detection unit F310 and the specification unit F320, which will be described later, based on moving information from each user terminal 200.

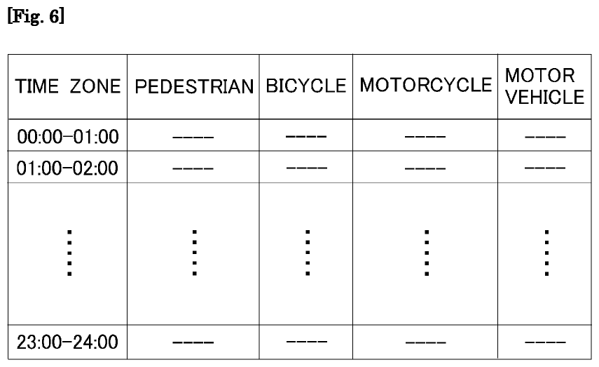

The second database D320 stores information related to estimated traffic volumes in individual time zones. In the second database D320, the types of the moving objects 100 and the estimated traffic volume of each type of moving objects 100 are associated with each other for each time zone. Here, a configuration example of the information stored in the second database D320 will be described based on FIG. 6. FIG. 6 is a view illustrating a table configuration of the second database D320. Here, note that the configuration of a table stored in the second database D320 (hereinafter, also referred to as an “estimated traffic volume table” in some cases) is not limited to the example illustrated in FIG. 6, but fields can be added, changed, or deleted as appropriate.

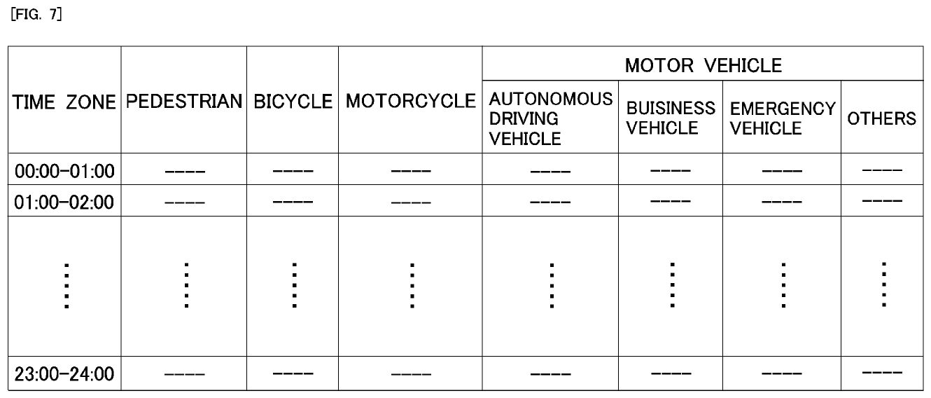

The estimated traffic volume table illustrated in FIG. 6 has individual fields for time zone, pedestrian, bicycle, motorcycle, and motor vehicle. In the time zone fields, time zones obtained by dividing 24 hours by a predetermined time (e.g., 1 hour) are registered. Estimated traffic volumes of pedestrians in individual time zones are registered in the pedestrian fields. Estimated traffic volumes of bicycles in the individual time zones are registered in the bicycle fields. Estimated traffic volumes of motorcycles in the individual time zones are registered in the motorcycle fields. Estimated traffic volumes of motor vehicles in the individual time zones are registered in the motor vehicle fields. Here, note that, as illustrated in FIG. 7, the motor vehicle fields may be divided into fields of autonomous driving vehicles, business vehicles, emergency vehicles, and others. In this case, estimated traffic volumes of autonomous driving vehicles in the individual time zones are registered in the autonomous driving vehicle fields. Estimated traffic volumes of business vehicles in the individual time zones are registered in the business vehicle fields. Estimated traffic volumes of emergency vehicles in the individual time zones are registered in the emergency vehicle fields. Estimated traffic volumes of motor vehicles other than the above (e.g., micro vehicles or the like) are registered in the others fields. The registration of the information for the above-mentioned individual fields is performed by the calculation unit F330, which will be described later, based on the above-mentioned moving object information table.

The detection unit F310 detects the moving objects 100 that are scheduled to pass through the predetermined road section. In this example, the detection unit F310 detects the moving objects 100 scheduled to pass through the predetermined road section, based on the moving information transmitted from each user terminal 200 to the server apparatus 300. Specifically, the detection unit F310 extracts, from among a plurality of pieces of moving information received by the server apparatus 300, moving information in which the predetermined road section is included in scheduled moving routes. Thus, it is detected that any type of moving object is scheduled to pass through the predetermined road section. Here, note that a moving object ID is assigned to each piece of the moving information extracted by the detection unit F310. Then, each piece of the moving information extracted by the detection unit F310 is passed to the specification unit F320 in a form associated with the moving object ID.

The specification unit F320 specifies the type of a moving object 100 based on the moving information extracted by the detection unit F310. Specifically, the specification unit F320 specifies the type of the moving object 100 on the basis of the moving method of a user in the predetermined road section in the user's scheduled moving route. Here, in cases where the moving method of the user in the predetermined road section is “walk”, the type of the moving object 100 detected by the detection unit F310 is specified as a “pedestrian”. In addition, in cases where the moving method of the user in the predetermined road section is “bicycle”, the type of the moving object 100 detected by the detection unit F310 is specified as a “bicycle”. Moreover, in cases where the moving method of the user in the predetermined road section is “motorcycle”, the type of the moving object 100 detected by the detection unit F310 is specified as a “motorcycle”. Here, in cases where the moving method of the user in the predetermined road section is “motor vehicle”, the type of the moving object 100 detected by the detection unit F310 is specified as a “motor vehicle”. When the type of the moving object 100 detected by the detection unit F310 is specified in this manner, the specification unit F320 specifies a time zone (scheduled passage time zone) in which the moving object 100 is scheduled to pass through the predetermined road section. The scheduled passage time zone is specified based on the scheduled moving time zone of the scheduled moving route. The information on the type and the scheduled passage time zone of the moving object 100 specified by the specification unit F320 is registered in the moving object information table of the first database D310 in a form associated with the moving object ID.

The calculation unit F330 calculates the type-specific estimated traffic volumes of moving objects for each time zone. Such a calculation is performed based on moving object information tables as described above. For example, when an estimated traffic volume of pedestrians in a time zone from 8 o'clock to 9 o'clock is calculated, the calculation unit F330 first extracts all of the moving object information tables in which “08:00-09:00” is registered in the time zone fields. Then, the calculation unit F330 calculates the estimated traffic volume of pedestrians in the time zone from 8 o'clock to 9 o'clock by counting the number of tables in which “pedestrian” is registered in the type fields among the moving object information tables thus extracted. In addition, in cases where an estimated traffic volume of bicycles in the same time zone is calculated, the calculation unit F330 counts the number of tables in which “bicycle” is registered in the type fields, among the moving object information tables in which “08:00-09:00” is registered in the time zone fields. Moreover, in cases where an estimated traffic volume of motorcycles in the same time zone is calculated, the calculation unit F330 counts the number of tables in which “motorcycle” is registered in the type fields, among the moving object information tables in which “08:00-09:00” is registered in the time zone fields. Further, in cases where an estimated traffic volume of motor vehicles in the same time zone is calculated, the calculation unit F330 counts the number of tables in which “motor vehicle” is registered in the type fields, among the moving object information tables in which “08:00-09:00” is registered in the time zone fields. For the other time zones, the type-specific estimated traffic volumes of the moving objects are calculated in the same procedure as described above. When the type-specific estimated traffic volumes for each time zone are calculated in this way, these type-specific estimated traffic volumes are registered in the estimated traffic volume table of the second database D320.

The setting unit F340 sets the number and types of lanes 500 to be formed in each time zone, based on the type-specific estimated traffic volumes in each time zone. At this time, the setting unit F340 first determines the number and types of lanes 500 to be formed in each time zone, based on the time-specific estimated traffic volumes in each time zone. Then, the setting unit F340 determines the position and type of each demarcation line (lane marking) to be marked by the road marking device 401 in each time zone, based on the number of lanes 500 thus determined. In addition, the setting unit F340 determines the contents of the regulatory signs to be displayed by the display device 402 in each time zone, based on the types of the lanes 500 thus determined. Then, the setting unit F340 transmits to the lane lighting apparatus 400 through the communication unit 304, a lane setting command that includes information specifying the position and the type of each demarcation line and information specifying the contents of the regulatory signs.

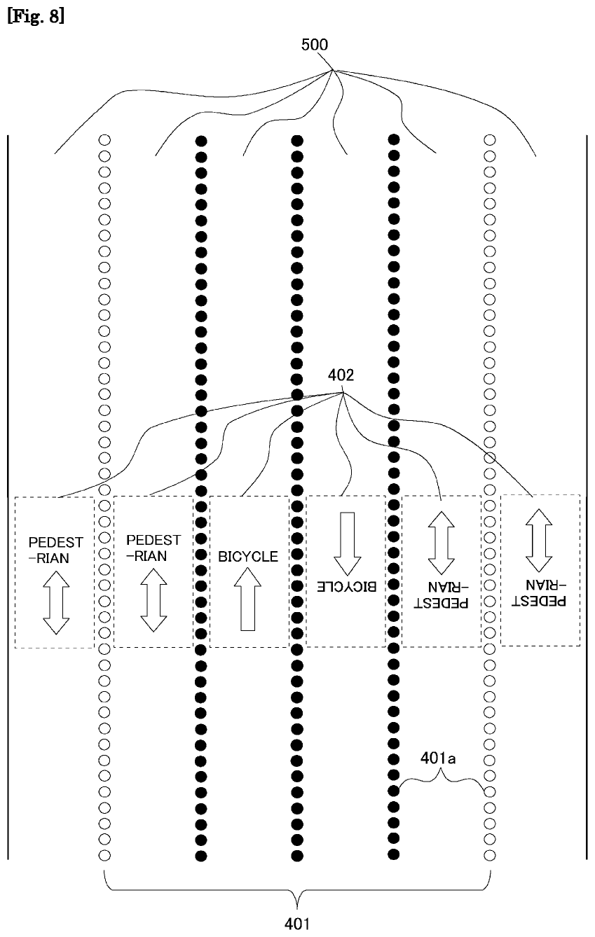

Here, an example of setting the number and types of lanes 500 to be formed in each time zone will be described. For example, in a time zone in which the sum of the estimated traffic volumes of pedestrians and bicycles (hereinafter, also referred to as a “first total volume” in some cases) is greater than the predetermined upper limit value, the whole of the predetermined road section may be set as lanes dedicated to pedestrians and bicycles, as illustrated in FIG. 8. The “predetermined upper limit value” in this case is, for example, a value that is considered to have a possibility that the passage of pedestrians and bicycles will be delayed if even at least one lane through which moving objects other than the pedestrians and bicycles are allowed to pass is formed in the predetermined road section in cases where the first total volume exceeds the predetermined upper limit value. Such a predetermined upper limit value is set based on, for example, the result of a simulation in consideration of a road width of the predetermined road section, etc.

In addition, in a time zone in which the first total volume is equal to or less than the predetermined upper limit value, the number and types of lanes may be set based on a ratio of the sum of the estimated traffic volumes of motorcycles and motor vehicles (hereinafter, also referred to as a “second total volume” in some cases) to the first total volume. For example, when the first total volume is greater than the second total volume, the number of lanes dedicated to pedestrians and bicycles may be set to be greater than the number of lanes dedicated to motorcycles and motor vehicles. On the other hand, when the second total volume is greater than the first total volume, the number of lanes dedicated to motorcycles and motor vehicles may be set to be greater than the number of lanes dedicated to pedestrians and bicycles.

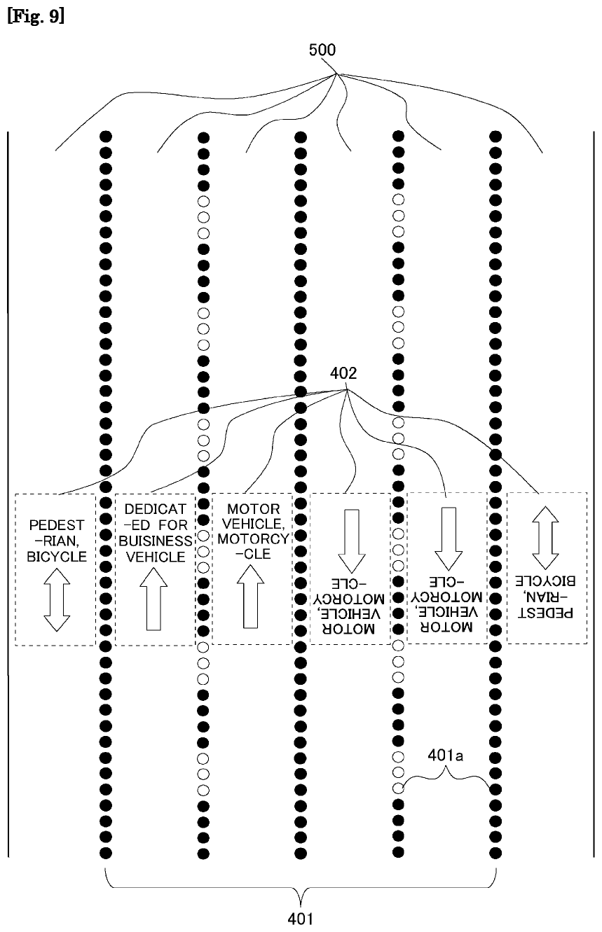

Moreover, as illustrated in FIG. 9, in a time zone in which a plurality of lanes (first lanes) through which motorcycles and motor vehicles are allowed to pass are set, when an estimated traffic volume of business vehicles is greater than a predetermined threshold value, a dedicated lane may be set for the business vehicles. That is, one of the plurality of first lanes may be set as a lane dedicated to the business vehicles. The “predetermined threshold value” in that case is a value that is assumed to make it difficult for business vehicles to smoothly pass through the predetermined road section, when the volume of business vehicles passing through the predetermined road section is greater than the predetermined threshold value. For example, such a predetermined threshold value may be set based on the estimated traffic volume of motor vehicles, or may be set based on a ratio of the estimated traffic volume of business vehicles to the estimated traffic volume of motor vehicles.

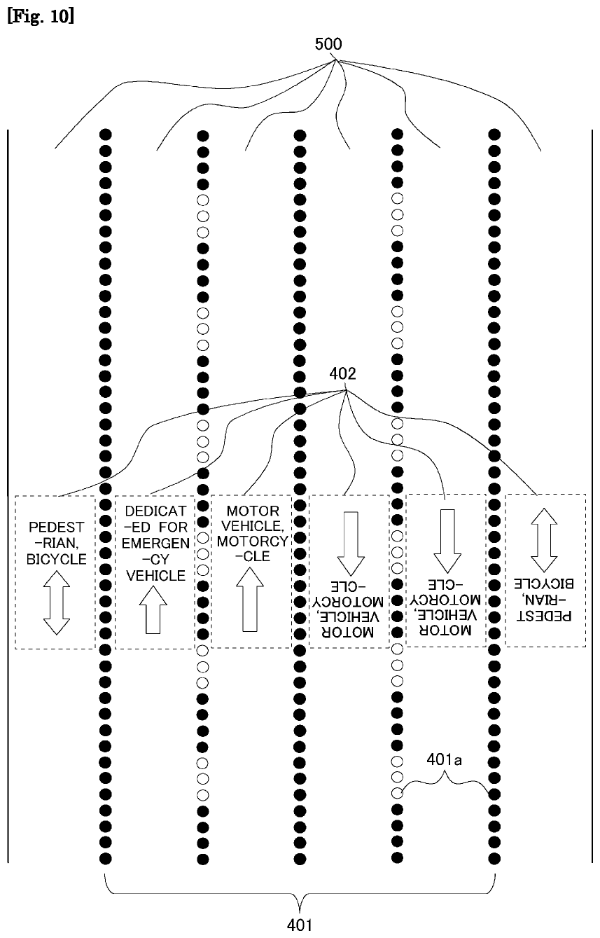

Further, in a time zone in which a plurality of first lanes are set, when an emergency vehicle is included in the motor vehicles scheduled to pass through the predetermined road section, a dedicated lane may be set for the emergency vehicle. For example, as illustrated in FIG. 10, one of the plurality of first lanes may be set as a lane dedicated to the emergency vehicle.

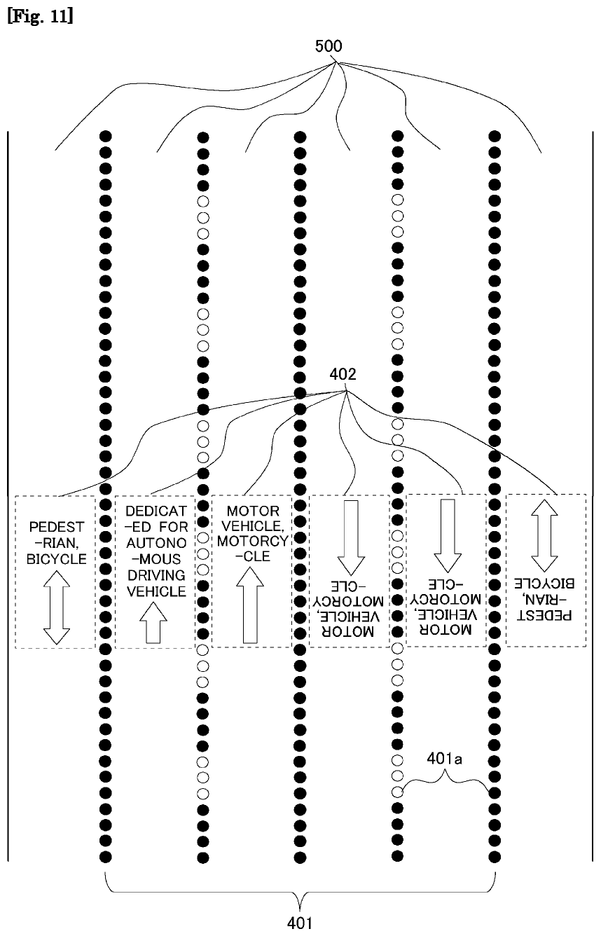

Furthermore, in a time zone in which a plurality of first lanes are set, when an estimated traffic volume of autonomous driving vehicles is greater than a predetermined threshold value, a dedicated lane may be set for the autonomous driving vehicles. For example, as illustrated in FIG. 11, one of the plurality of first lanes may be set as a lane dedicated to the autonomous driving vehicles. Here, note that, from the viewpoint of enhancing the traffic safety of motor vehicles, it is desirable that the autonomous driving vehicles and the manual driving vehicles travel in lanes different from each other. On the other hand, when at least one of the lanes through which motor vehicles are allowed to pass is set as a lane dedicated to the autonomous driving vehicles, there will be a possibility that congestion is likely to occur in a lane through which the manual driving vehicles are allowed to pass. Therefore, the “predetermined threshold value” referred to herein is set to a value that is assumed to be appropriate for achieving a balance between traffic safety and congestion suppression. Such a predetermined threshold value is set based on, for example, past records, simulation results, or the like.

Still further, in a time zone in which a plurality of first lanes are set, when the estimated traffic volume of motorcycles is greater than a predetermined threshold value, one of the plurality of first lanes may be set as a lane dedicated to the motorcycles.

Here, note that the method of setting the number and types of lanes is not limited to the examples described above, but may be changed as appropriate based on the state (e.g., congestion information) of a road that bypasses the predetermined road section or the like.

(Flow of Processing)

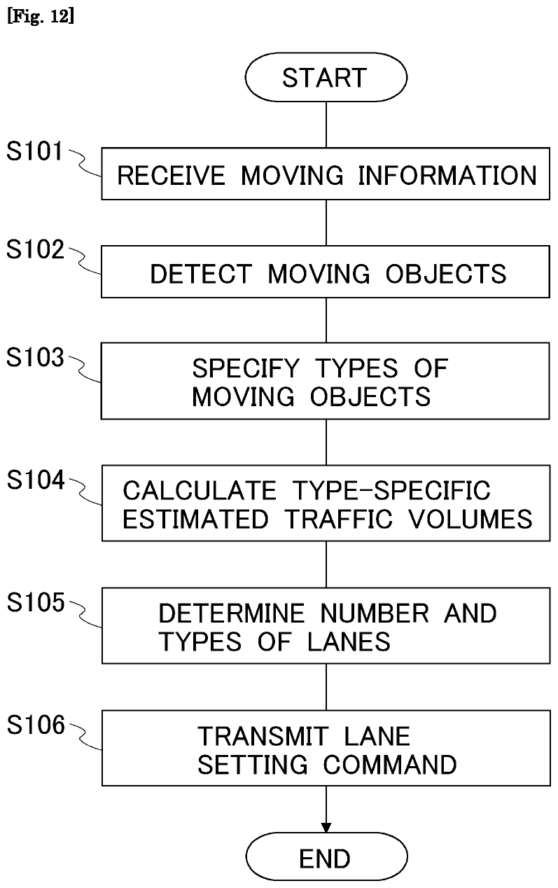

Next, a flow of processing performed by the server apparatus 300 will be described based on FIG. 12. FIG. 12 is a flowchart illustrating the flow of processing performed by the server apparatus 300 at a predetermined cycle.

In FIG. 12, when the communication unit 304 of the server apparatus 300 receives the moving information transmitted from each user terminal 200 (step S101), the detection unit F310 detects the moving objects 100 scheduled to pass through the predetermined road section, based on the moving information (step S102). For example, as described above, the detection unit F310 extracts, from among a plurality of pieces of the moving information received by the server apparatus 300, moving information in which the predetermined road section is included in a scheduled moving route. In cases where the moving information in which the predetermined road section is included in the scheduled moving route is extracted, the detection unit F310 assigns a moving object ID to the moving information thus extracted. Then, the detection unit F310 passes the moving information and the moving object ID to the specification unit F320 in a form associated with each other.

The specification unit F320 specifies the type of the moving object 100 scheduled to pass through the predetermined road section based on the moving information received from the detection unit F310 (step S103). For example, as described above, the specification unit F320 extracts, from the information related to the moving method for the scheduled moving route, the moving method of the user in the predetermined road section. Then, the specification unit F320 specifies the type of the moving object 100 scheduled to pass through the predetermined road section based on the moving method specified. In addition, the specification unit F320 specifies a time zone (scheduled passage time zone) in which the moving object 100 is scheduled to pass through the predetermined road section, based on the scheduled moving time zone of the scheduled moving route. Then, the specification unit F320 registers the information related to the type of the moving object 100 and the scheduled passage time zone thereof in the moving object information table of the first database D310 in a form associated with the moving object ID.

The calculation unit F330 of the server apparatus 300 calculates the type-specific estimated traffic volumes for each time zone (step S104). For example, the calculation unit F330 calculates the type-specific estimated traffic volumes for each time zone based on the moving object information table, as described above. The type-specific estimated traffic volumes for each time zone calculated by the calculation unit F330 are registered in the estimated traffic volume table of the second database D320.

The setting unit F340 of the server apparatus 300 determines the number and types of lanes 500 to be formed in each time zone based on the type-specific estimated traffic volumes in each time zone (step S105). At this time, the setting unit F340 determines the number and types of lanes 500 to be formed in each time zone, for example, by the methods described above with reference to FIGS. 8 through 11. Then, the setting unit F340 transmits a command (lane setting command) for forming the lanes 500 of the number and types thus determined in the predetermined road section to the lane lighting apparatus 400 (step S106). As described above, the lane setting command includes information specifying the positions and types of demarcation lines and information specifying the contents of regulatory signs. When such a lane setting command is received by the lane lighting apparatus 400, the road marking device 401 controls the light emitters 401a based on the information specifying the positions and types of demarcation lines (lane markings). For example, first, the road marking device 401 specifies the light emitters 401a in a column corresponding to the position of each demarcation line. Subsequently, the road marking device 401 determines those light emitters 401a which should emit light (in other words, those light emitters 401a which should not emit light) among the light emitters 401a in the specified column, according to the type of each demarcation line. Then, the road marking device 401 controls the emission and non-emission of each light emitter 401a on the basis of the contents of determination, thereby forming on a road surface the demarcation lines with the number and types designated by the lane setting command. In addition, the display device 402 displays the regulatory signs having the contents designated by the lane setting command. Thus, the number and types of lanes specified by the lane setting command are formed in the predetermined road section.

According to the embodiment described above, the number and types of the lanes 500 to be formed in the predetermined road section can be appropriately and flexibly changed in accordance with the type-specific estimated traffic volumes in the predetermined road section. As a result, even if the volume and types of moving objects passing through the predetermined road section change in a fluid manner, it is possible to make smooth the traffic of the moving objects. Therefore, a road with a limited width can be used in an efficient and effective manner.

### <Others>

The above-described embodiment is merely an example, and the present disclosure can be appropriately modified and implemented within a range not departing from the gist thereof. In addition, the processing (processes) and means (devices, units, measures, etc.) described in the present disclosure can be freely combined and implemented as long as no technical contradiction occurs. Further, the processing described as being performed by a single device, unit or the like may be shared and executed by a plurality of devices, units or the like. Alternatively, the processing described as being performed by different devices, units or the like may be performed by a single device, unit or the like. In a computer system, it is possible to flexibly change the hardware configuration that can achieve each function of the computer system.

The present disclosure can also be realized by supplying to a computer a computer program in which the functions described in the above-mentioned embodiment are implemented, and by reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium is a recording medium that can accumulate information, such as data, programs and the like, by electrical, magnetic, optical, mechanical, or chemical action, and can be read from the computer or the like. Such a recording medium is, for example, any type of disk such as a magnetic disk (a floppy (registered trademark) disk, a hard disk drive (HDD), etc.), an optical disc (a CD-ROM, a DVD disc, a Blu-ray disc, etc.) or the like, a read-only memory (ROM), a random-access memory (RAM), an EPROM, an EEPROM, a magnetic card, a flash memory, an optical card, a solid state drive (SSD), and so on.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. An information processing apparatus comprising a controller including at least one processor,
the controller configured to execute:
detecting moving objects that are scheduled to pass through a predetermined road section;
specifying types of the moving objects scheduled to pass through the predetermined road section;
calculating an estimated traffic volume for each type of the moving objects scheduled to pass through the predetermined road section; and
setting at least one of a number and types of lanes to be formed in the predetermined road section based on the estimated traffic volume for each type of the moving objects scheduled to pass through the predetermined road section.

2. The information processing apparatus according to claim 1, wherein the types of the moving objects include at least one of a pedestrian, a bicycle, a motorcycle, and a motor vehicle.

3. The information processing apparatus according to claim 2, wherein in cases where the estimated traffic volume of a first type of moving objects is greater than the estimated traffic volume of a second type of moving objects, in the moving objects that are scheduled to pass through the predetermined road section, the controller sets the number of lanes through which the first type of moving objects are allowed to pass to be greater than the number of lanes through which the second type of moving objects are allowed to pass.

4. The information processing apparatus according to claim 2, wherein in cases where a plurality of first lanes through which motor vehicles are allowed to pass are set in the predetermined road section, the controller sets at least one of the plurality of first lanes as a lane dedicated to business vehicles, when an estimated traffic volume of business vehicles among motor vehicles scheduled to pass through the predetermined road section is greater than a predetermined threshold value.

5. The information processing apparatus according to claim 2, wherein in cases where a plurality of first lanes through which motor vehicles are allowed to pass are set in the predetermined road section, the controller sets at least one of the plurality of first lanes as a lane dedicated to autonomous driving vehicles, when an estimated traffic volume of autonomous driving vehicles among motor vehicles scheduled to pass through the predetermined road section is greater than a predetermined threshold value.

6. The information processing apparatus according to claim 2, wherein in cases where a sum of an estimated traffic volume of pedestrians and an estimated traffic volume of bicycles exceeds a predetermined upper limit value, the controller sets the whole of the predetermined road section as lanes dedicated to pedestrians and bicycles.

7. The information processing apparatus according to claim 1, wherein the controller detects the moving objects scheduled to pass through the predetermined road section, by obtaining a scheduled moving route of each moving object, and extracting those moving objects which include the predetermined road section in their scheduled moving routes.

8. The information processing apparatus according to claim 7, wherein the controller specifies the types of the moving objects scheduled to pass through the predetermined road section by obtaining information related to the types of the moving objects in the predetermined road section in their scheduled moving routes.

9. The information processing apparatus according to claim 1, wherein
in the predetermined road section, there are provided a road marking device configured to form road markings indicating demarcation lines at optional positions, and a display device configured to display regulatory signs for regulating the types of lanes; and
the controller sets the number of lanes to be formed in the predetermined road section by changing the positions and the number of the road markings to be formed by the road marking device, and sets the type of each lane by changing the regulatory signs to be displayed by the display device.

10. An information processing method for causing a computer to execute:
a detection step of detecting moving objects that are scheduled to pass through a predetermined road section;
a specification step of specifying types of the moving objects scheduled to pass through the predetermined road section;
a calculation step of calculating an estimated traffic volume for each type of the moving objects scheduled to pass through the predetermined road section; and
a setting step of setting at least one of a number and types of lanes to be formed in the predetermined road section based on the estimated traffic volume for each type of the moving objects scheduled to pass through the predetermined road section.

11. The information processing method according to claim 10, wherein the types of the moving objects include at least one of a pedestrian, a bicycle, a motorcycle, and a motor vehicle.

12. The information processing method according to claim 11, wherein in cases where an estimated traffic volume of a first type of moving objects is greater than an estimated traffic volume of a second type of moving objects, in the moving objects that are scheduled to pass through the predetermined road section, in the setting step, the number of lanes through which the first type of moving objects are allowed to pass is set to be greater than the number of lanes through which the second type of moving objects are allowed to pass.

13. The information processing method according to claim 11, wherein in cases where a plurality of first lanes through which motor vehicles are allowed to pass are set in the predetermined road section, in the setting step, at least one of the plurality of first lanes is set as a lane dedicated to business vehicles, when an estimated traffic volume of business vehicles among motor vehicles scheduled to pass through the predetermined road section is greater than a predetermined threshold value.

14. The information processing method according to claim 11, wherein in cases where a plurality of first lanes through which motor vehicles are allowed to pass are set in the predetermined road section, in the setting step, at least one of the plurality of first lanes is set as a lane dedicated to autonomous driving vehicles, when an estimated traffic volume of autonomous driving vehicles among motor vehicles scheduled to pass through the predetermined road section is greater than a predetermined threshold value.

15. The information processing method according to claim 11, wherein in cases where a sum of an estimated traffic volume of pedestrians and an estimated traffic volume of bicycles exceeds a predetermined upper limit value, in the setting step, the whole of the predetermined road section is set as lanes dedicated to pedestrians and bicycles.

16. The information processing method according to claim 10, wherein the detection step includes:
a step of obtaining a scheduled moving route of each moving object; and
a step of extracting those moving objects which include the predetermined road section in their scheduled moving routes.

17. The information processing method according to claim 16, wherein the specification step includes a step of obtaining information related to the types of the moving objects in the predetermined road section of the scheduled moving routes.

18. The information processing method according to claim 10, wherein
in the predetermined road section, there are provided a road marking device configured to form road markings indicating demarcation lines at optional positions, and a display device configured to display regulatory signs for regulating the types of lanes; and
in the setting step, the number of lanes to be formed in the predetermined road section is set by changing the positions and the number of the road markings to be formed by the road marking device, and the type of each lane is set by changing the regulatory signs to be displayed by the display device.

19. An information processing system comprising:
a road marking device arranged in a predetermined road section and configured to change positions and a number of lanes to be formed in the predetermined road section by forming road markings indicating demarcation lines at optional positions;
a display device arranged in the predetermined road section and configured to display regulatory signs for regulating types of lanes to be formed in the predetermined road section; and
an information processing apparatus for controlling the road marking device and the display device;
wherein the information processing apparatus comprising a controller including at least one processor,
the controller configured to execute:
detecting moving objects that are scheduled to pass through the predetermined road section;
specifying types of the moving objects scheduled to pass through the predetermined road section;
calculating an estimated traffic volume for each type of the moving objects scheduled to pass through the predetermined road section; and
setting a number and types of the lanes to be formed in the predetermined road section by changing the positions and number of the road markings to be formed by the road marking device and by changing the regulatory signs to be displayed by the display device, based on the estimated traffic volume for each type of the moving objects scheduled to pass through the predetermined road section.

20. The information processing system according to claim 19, wherein the types of the moving objects include at least one of a pedestrian, a bicycle, a motorcycle, and a motor vehicle.
